(19) United States
(12) Patent Application Publication
(10) Pub. No.: US 2015/0328793 A1
(43) Pub. Date: Nov. 19, 2015

(54) CUTTING BLADE HAVING A CHANGING CUTTING ANGLE

(71) Applicant: GEA FOOD SOLUTIONS GERMANY GMBH, Biedenkopf-Wallau (DE)

(72) Inventors: Ralf-Peter Müller, Kempten (DE); Florian Schneid, Haldenwang (DE); Winfried Hörberg, Obergünzburg (DE)

(21) Appl. No.: 14/761,451

(22) PCT Filed: Jan. 20, 2014
(86) PCT No.: PCT/EP2014/050983

§ 371 Date: Jul. 16, 2015

(30) Foreign Application Priority Data
Jan. 25, 2013 (DE) 10 2013 201 230.6

(51) Int. Cl. B26D 1/00; B26D 7/12

(52) U.S. Cl. CPC B26D 1/0006; B26D 7/12; B26D 2001/006

(57) ABSTRACT

The present invention relates to a cutting blade for machines for slicing food products, in particular for high-speed slicers, wherein the cutting blade is a sickle blade, which rotates about an axis of rotation during the cutting operation and which has a cutting edge that deviates from a circular shape, in particular that revolves around the axis of rotation in the manner of a spiral, at the radially outer perimeter of the sickle blade, which cutting edge lies in a cutting plane extending perpendicularly to the axis of rotation, wherein the cutting edge forms the radially outer end of the cutting surface, which forms part of the blade back side facing away from the product to be sliced during the cutting operation and includes a cutting angle with the cutting plane, and wherein the size of the cutting angle varies in the circumferential direction of the cutting blade. The present invention further relates to a cutting blade grinding device.

The present invention relates to a cutting blade for machines for slicing foodstuffs, in particular for high-speed slicers, wherein the cutting blade is a sickle blade which during the cutting operation rotates about a center of rotation and which on its radially outer circumference has a cutting edge which deviates from a circular shape and, in particular, in a spiral manner encircles the center of rotation and which lies in a cutting plane which runs perpendicularly to the center of rotation, wherein the cutting edge forms the radially outer end of the cutting face which forms part of the reverse side of the blade which during the cutting operation faces away from a product to be sliced and which with the cutting plane encloses a blade angle, and wherein the size of the blade angle varies in the circumferential direction of the cutting blade. The present invention furthermore relates to a cutting blade grinding device, and to the use of the cutting blade for cutting foodstuffs.

Cutting blades of this type are known from the prior art, for example EP 1 598 159. EP 08 785 722 A2 is further prior art. A person skilled in the art continually strives to provide cutting blades in which:
the product is compressed as little as possible during cutting;
the severed slice assumes the desired trajectory; and/or
they have as long a service life as possible and/or are comparatively easy to manufacture.

Therefore, the object of the present invention has been to provide a blade of this type.

The object is achieved by a cutting blade for machines for slicing foodstuffs, in particular for high-speed slicers, wherein the cutting blade is a sickle blade which during the cutting operation rotates about a center of rotation and which on its radially outer circumference has a cutting edge which deviates from a circular shape and, in particular, in a spiral manner encircles the center of rotation and which lies in a cutting plane which runs perpendicularly to the center of rotation, wherein the cutting edge forms the radially outer end of the cutting face which forms part of the reverse side of the blade which during the cutting operation faces away from a product to be sliced and which with the cutting plane encloses a blade angle, and wherein the size of the blade angle varies in the circumferential direction of the cutting blade, and wherein the blade angle varies only in part-regions of the cutting edge which runs in the circumferential direction.

The narratives provided for this subject matter of the present invention apply in equal measure to the other subject matter of the present invention, and vice-versa.

The present invention relates to a cutting blade which is employed for slicing foodstuffs, in particular for high-speed slicers. In high-speed slicers the product, for example a block of sausage, ham, or cheese, is continuously or intermittently conveyed in the direction of the rotating cutting blade which severs foodstuff slices from the leading end of the foodstuff. These foodstuff slices then fall onto a delivery table, for example, on which the former are configured to form a portion of ten slices, for example. Once a portion of this type has been completed, it is conveyed out of the cutting range of the blade, and a new portion can be sliced.

The cutting blade according to the invention is a sickle blade. The blade may have a saucer-type or bowl-type shape or a hollow structure. The cutting blade on its radially outer circumference has a cutting edge which lies in a cutting plane which runs perpendicularly to the center of rotation of the cutting blade. The cutting edge here forms the radially outer end of a cutting face which forms part of the reverse side of the blade which during the cutting operation faces away from the product to be sliced and which with the cutting plane encloses a blade angle. According to the invention, the size of this blade angle varies in the circumferential direction of the cutting blade, wherein, however, the blade angle varies only in part-regions of the cutting edge which runs in the circumferential direction.

On account of the blade angle varying only in part-regions of the cutting edge which runs in the circumferential direction, the cutting blade according to the invention can be manufactured in a more cost-effective manner than cutting blades which are disclosed for example in EP 08 785 722 A2. It has furthermore been found that it is positive in terms of the cutting behavior or the trajectory of the severed foodstuff slice, respectively, for the blade angle to vary only in part-regions of the cutting edge which runs in the circumferential direction and for the entire cutting edge not to have a variable blade angle.

Preferably, the blade angle varies consistently in a part-region of the cutting edge.

According to another or a preferred subject matter of the present invention, the blade angle varies inconsistently. This inconsistent variation of the blade angle may extend across only part-regions of the cutting edge or across the entire length. Inconsistent in the context of the invention means that said variation is not consistent in the mathematical sense, that is to say that the blade angle varies in jumps, for example, having a step, and/or in a kinked manner.

On account of these inconsistent points, the blade angle may remain constant and then vary in steps, for example. On account thereof, manufacturing and sharpening the cutting blade is substantially simpler than in the case of a consistent variation of the blade angle across the entire profile of the cutting edge, such as claimed for example in EP 08 785 722 A2. Moreover, on account of the inconsistent point of the blade, the foodstuff slice to be severed receives an additional impulse which moves said foodstuff slice away from the product and/or shapes said foodstuff slice, for example.

The narratives provided for this subject matter of the present invention apply in equal measure to the other subject matter of the present invention, and vice-versa.

Preferably, an inconsistent point is located from a transition from one blade angle to another blade angle.

The following narratives apply in equal measure to all subject matter of the present invention.

Preferably, the blade angle increases counter to the direction of rotation of the cutting blade.

Furthermore preferably, the blade angle increases as the radial spacing of the cutting edge from the center of rotation of the cutting blade increases.

According to the invention or preferably, the cutting edge has at least one, preferably a plurality of portion(s) in which the blade angle does not vary. Preferably, a portion comprises 1 to 120°, particularly preferably 5 to 90°, very particularly preferably 10 to 70°, and most preferably 6 to 30°.

Preferably, the cutting face has inconsistent points.

Preferably, the blade angle is 15 to 45°, particularly preferably 20 to 30°.

A further subject matter of the present invention is the use of the cutting blade according to the invention for slicing a foodstuff into foodstuff slices, wherein the cutting blade rotates during slicing.

A further subject matter of the cutting blade grinding device, in particular for grinding a cutting blade as claimed in one of the preceding claims, wherein the cutting blade rotates about its center of rotation during grinding and the angular position of a grinding means, in particular of a grinding disk, is varied in one region and is kept constant in another region depending on the rotation angle of the cutting blade.

This subject matter of the present invention relates to a grinding machine for sharpening a blade in which the blade angle of the cutting blade varies. According to the invention, it is provided that the angular position of the grinding disk is varied depending on the rotation angle of the cutting blade. To this end, the cutting blade is clamped in the grinding machine in a very specific angular position, and the cutting edge or the cutting face, respectively is ground using a moving, in particular rotating, grinding means, for example a grinding disk; once this grinding operation has been terminated, or during grinding, the cutting blade is rotated further by a specific angular segment, and the next portion of the cutting edge is ground. The rotation angle of the cutting blade which has been covered here is electronically measured, for example, and the grinding means is adjusted so as to correspond to a stored program, depending on the rotation-angle position of the cutting blade. Alternatively, a mechanism, for example a curve-and-cam controller, which causes the variation of the angle of the grinding means depending on the rotation-angle position of the cutting blade, may be also be activated by the rotation of the cutting blade. By varying the angle of the grinding means, a cutting face having different blade angles may be produced.

Preferably, the grinding means, in particular a rotating grinding disk, by way of for example spring pressure bears on a stop which is adjustable for the angular position. By way of a continuous or intermittent rotating movement, the cutting blade is moved about its center of rotation with the cutting edge of said cutting blade moving along the grinding disk, wherein the grinding disk radially follows a gate which corresponds to the cutting edge. From a certain rotation angle onward, an additional gate/curve contacts the mechanism for the angular position of the grinding disk and raises the latter away from the stop, counter to the spring pressure.

Preferably, the variation of the angular positioning of the grinding disk is performed consistently and/or in jumps.

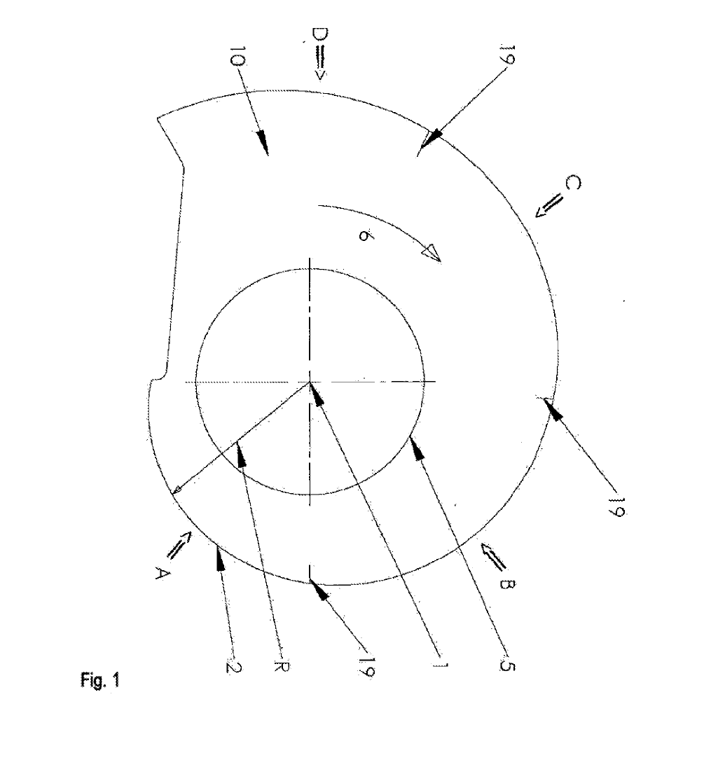

The inventions will be explained in the following by means of FIGS. 1 to 4. These explanations are merely exemplary and do not limit the general concept of the invention. The explanations apply in equal measure to all subject matter of the present invention. In the figures:

FIG. 1 shows a plan view of the cutting blade according to the invention;

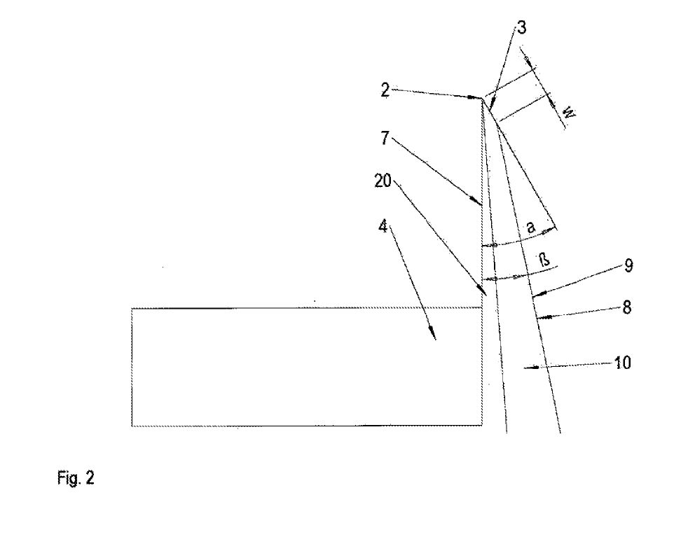

FIG. 2 shows in part a cross-sectional view of a cutting blade according to the invention;

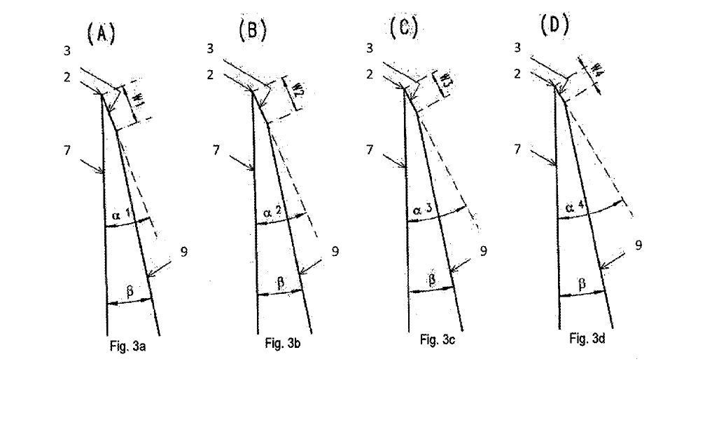

FIG. 3 shows a plurality of cross-sectional views of a cutting blade according to the invention at various circumferential regions;

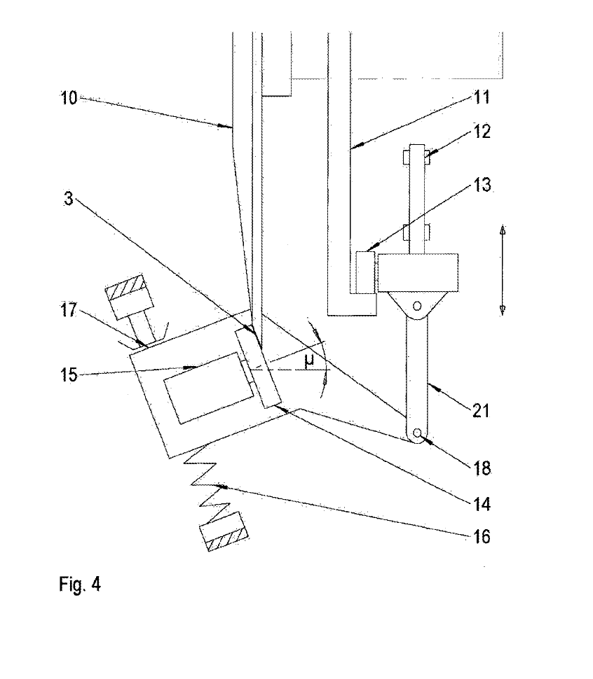

FIG. 4 shows the cutting blade grinding device according to the invention.

The cutting blade according to FIG. 1 is a so-called sickle blade which rotates about a center of rotation 1 in the direction which is identified by the arrow 6 and thereby, by way of its cutting edge 2, plunges into a product 4 and thereafter severs a slice from the product. The cutting blade according to the invention is fastened by means of the clearance 5 and/or fastening means (not illustrated) on a rotating shaft of a slicing device. The spacing of the cutting edge from the center of rotation of the cutting blade, which increases counter to the direction of rotation 6 of the cutting blade, is represented by the reference sign R, such that the blade is configured so as to be spiral. The product typically plunges into the product by way of the region which is identified by the reference sign A, and by way thereof and the regions B, C, and/or D the foodstuff slice is severed from the product. The transition from one region to another is symbolized by the reference sign 19. A person skilled in the art will appreciate that a plurality of slices of a plurality of products which lie beside one another may be severed during one revolution of the blade.

It can be seen by means of FIG. 2 that the sickle blade according to the invention in the present case has a saucer-type or bowl-type shape. On account thereof, the inner side of the blade is recessed in relation to the cutting plane 7 which runs perpendicularly to the center of rotation 1, such that a free space 20 is created and the cutting blade thus only partially contacts the product. The blade according to the invention on the reverse side of the blade 8 has a surface 9. Likewise on the reverse side, a cutting face 3, which is provided at a specific blade angle α, adjoins the cutting edge 2, wherein the blade angle α is the angle between the cutting plane 7 and the blade face 3. This angle α is typically larger than the angle β between the cutting plane 7 and the surface 9 of the reverse side of the blade. According to the invention, the blade angle α now varies along the cutting edge 2, but only in a part-region of the cutting edge 2 which runs in the circumferential direction. This is illustrated in FIG. 3. FIG. 3a shows the plunging region A, FIGS. 3b to 3d show the regions B to D according to FIG. 1. In the plunging region A, the blade angle has a constant value of a1, for example, and in the further regions B, C, and D has a constant value a2, a3, and a4, respectively, wherein the blade angles at the inconsistent point 19 in each case preferably vary inconsistently. According to an alternative embodiment, the blade in the plunging region has a blade angle of a1, and in the regions “B”, “C”, and “D” the blade angles a2, a3, and a4, are in each case identical, for example. According to a further alternative embodiment, it is also possible for the blade angle to be constant in the portions “B” and “C” and to merely be smaller in the region “A” and larger in the region “D”, or vice-versa. A person skilled in the art will recognize that even many other combinations are possible. According to the invention, it need only be ensured that the variation of the blade angles is inconsistent from one region to another and/or that the blade angle is varied only in part-regions of the cutting edge and remains constant in at least one other region.

FIG. 4 shows the cutting blade grinding device according to the invention. The cutting blade 10 is provided in a rotationally fixed manner on a rotating shaft on which also a rotary cam 11 is disposed in a rotationally fixed manner. The cutting face 3 of the cutting blade 10 is ground by means of a grinding means 14, presently a rotating grinding disk 14, which bears on the cutting face 3 of the cutting blade. This grinding disk 14 is pressed against a stop 17 by means of a spring means 16, and is adjustable in its angle μ in relation to the horizontal. This adjustment is performed by means of a cam 13, presently a roller 13 which is displaceably mounted in a friction bearing 12, such that the lever 21 which is connected to the roller 13 may carry out the movement which is identified by the double arrow. This lever 21 is connected to the grinding means 14, 15 by means of a connecting means 18, such that the grinding means 14, 15 is varied in its angle by an up-and-down movement of the connecting means 18. The variation of the angle μ of the grinding means 14, 15 is predefined by the rotary cam 11 which rotates in a synchronous manner with the cutting blade 10. On account thereof, it is possible to provide the cutting face with different blade angles.

### LIST OF REFERENCE SIGNS

1 Center of rotation
2 Cutting edge
3 Cutting face
4 Product
5 Clearance
6 Direction of rotation
7 Cutting plane
8 Reverse side of blade
9 Surface of rear side of blade
10 Cutting blade
11 Rotary cam
12 Friction bearing
13 Roller
14 Grinding means
15 Rotary drive
16 Spring means
17 Stop
18 Connecting means
19 Transition between different circumferential regions, inconsistent points
20 Free space
Lever
α Blade angle
β Angle between front and reverse side of blade 10
μ Angular position of the grinding disk
R Radial spacing of the cutting edge from the blade center
A Plunging region
B-D Circumferential regions of the blade
w1-w4 Width of the cutting face

What is claimed is:

1. A cutting blade for machines for slicing foodstuffs comprising:
a radially outer circumference;
a cutting edge on the radially outer circumference;
wherein the cutting blade is a sickle blade which during the cutting operation rotates about a center of rotation and the cutting edge deviates from a circular shape in a spiral manner and encircles the center of rotation which lies in a cutting plane which runs perpendicularly to the center of rotation,
wherein the cutting edge forms a radially outer end of a cutting face which forms part of a reverse side of the cutting blade which during the cutting operation faces away from a product to be sliced and which with the cutting plane encloses a blade angle (α), and
wherein a size of the blade angle (α) varies in a circumferential direction of the cutting blade and the blade angle (α) varies only in-part regions of the cutting edge which runs in the circumferential direction,
wherein the blade angle (α) increases counter to the direction of rotation of the cutting blade.

2. The cutting blade as claimed in claim 1, wherein the blade angle varies consistently.

3. The cutting blade as claimed in claim 1, wherein the blade angle (α) varies inconsistently.

4. (canceled)

5. The cutting blade as claimed in claim 1, wherein the blade angle (α) increases as the radial spacing (R) of the cutting blade increases.

6. (canceled)

7. (canceled)

8. (canceled)

9. (canceled)

10. A cutting blade grinding device for grinding a cutting blade as claimed in claim 1, wherein the cutting blade rotates about its center of rotation during grinding, and
wherein an angular position (μ) of the grinding disk is kept constant depending on the rotation-angle regions of the blade and is varied in other regions.

11. The cutting blade grinding device as claimed in claim 10, wherein a variation of angular positioning is performed by a curve-and-cam controller, a gate, or in a computer-controlled manner.

12. The cutting blade grinding device as claimed in claim 10, wherein a variation of angular positioning of the grinding disk is performed consistently and/or in jumps.

13. The cutting blade as claimed in claim 1, wherein the variation of the blade angle (α) is performed by way of inconsistent points in the cutting face.

14. The cutting blade as claimed in claim 1, wherein the blade angle is performed in a range of 15 to 45°.

15. The cutting blade as claimed in claim 1, wherein the blade angle is performed in a range of 20 to 30°.

16. The cutting blade as claimed in claim 13, wherein the blade angle is performed in a range of 20 to 30°.

17. The cutting blade as claimed in claim 1, wherein he machine for slicing foodstuffs is a high-speed slicer.

18. A method of slicing, wherein the cutting blade of claim 1 rotates during slicing.

19. The cutting blade as claimed in claim 2, wherein the blade angle (α) increases as the radial spacing (R) of the cutting blade increases.

20. The cutting blade as claimed in claim 3, wherein the blade angle (α) increases as the radial spacing (R) of the cutting blade increases.
